(19) United States
(12) Patent Application Publication
(10) Pub. No.: US 2005/0102140 A1
(43) Pub. Date: May 12, 2005

(54) Method and system for real-time transcription and correction using an electronic communication environment

(76) Inventors: Joel Davne, New Hope, PA (US); Milan diPierro, Manasquan, NJ (US); George Kustas, Poughkepsie, NY (US)

Correspondence Address: PEPPER HAMILTON LLP, ONE MELLON CENTER, 50TH FLOOR, 500 GRANT STREET, PITTSBURGH, PA, 15219, US

(21) Appl. No.: 10/988,299

(22) Filed: Nov. 12, 2004

Related U.S. Application Data
(60) Provisional application No. 60/519,241, filed on Nov. 12, 2003.

(51) Int. Cl. G10L 15/00

(52) U.S. Cl. 704/235

(57) ABSTRACT

A method and system for transcribing dictation information from an author in an electronic communication environment and permitting real-time review and correction of the transcribed information by the author is disclosed. An author may request either a particular or next-available transcriptionist for transcribing a document using a first communication device. If a transcriptionist accepts the request using a second communication device, a communication session is initiated. The author dictates information using the first communication device. The transcriptionist receives the information via the second communication device and transcribes the information. As the information is transcribed, the first communication device displays the transcribed information substantially in real time. The author and/or the transcriptionist may edit the displayed information during the communication session. When transcription of the information is completed, the transcribed information is stored, and the communication session is terminated.

### CLAIM OF PRIORITY

This application claims priority to U.S. Provisional Patent Application Serial No. 60/519,241, filed Nov. 12, 2003, entitled “Method and System for Real-Time Transcription and Correction Using an Electronic Communication Environment,” which is incorporated herein by reference in its entirety.

### TECHNICAL FIELD

The present invention relates generally to the field of transcription of audio signals. Specifically, the invention relates to a method and system for transcribing dictation from an author in an electronic communication environment and permitting real-time review and correction of the transcribed information by the author.

### BACKGROUND

In many professions, it is necessary to transcribe spoken information into written information. Initially, stenography and shorthand were used to record a speaker's words as they were spoken. One problem with such methods of recording speech is that no permanent record of the speech exists other than the stenographer's notes. If a word is misheard or the stenographer is distracted, the information is lost.

Several devices have been suggested for recording and preserving audio data. The most common of these devices is the conventional dictation-recording device that records an author's dictation on a magnetic tape. A tape recorder can reproduce the dictation by reading recorded information from the magnetic tape and generating an electric signal representative of the recorded information. In order to transcribe the recorded information, the author typically provides the magnetic tape to a typist who prepares a typewritten transcript by playing the magnetic tape in a device that generates an acoustic reproduction of the dictation. While listening to the reproduction of the dictation, the typist types a transcript of the dictation on the keyboard of a typewriter or word processing device.

Typically, professionals, and in particular medical professionals such as physicians, nurse practitioners, nurses, therapists and the like, have widely used handheld and/or desk-mounted dictation devices to record their activities. A medical professional's descriptions of interactions with patients, whether in the office, the hospital or the operating room, are vital to the delivery of quality health care. Furthermore, documentation by the medical professional is mandatory for legal purposes, to meet demands of regulatory bodies, and for effective business practices, including efficient billing, contractual compliance and the like. The permanent records of a medical professional's activities are typically kept in the medical record or “chart” of the patient or other professional records.

If a medical professional does not use a tape recorder to record day-to-day activities, records are sometimes handwritten. On occasion, a medical professional will also use a telephone to dictate notes to a remote receiving unit, usually located at a transcription location. At the transcription location, a medical secretary or other typist transcribes the spoken notes into text using a typewriter or word processor. The typed dictation is later sent to the medical professional's office, where it is placed in the appropriate patient's medical record.

Each of the foregoing prior art techniques has one or more drawbacks. For example, when either a hand-held or desk-mounted tape recorder is used, the medical professional must physically acquire a magnetic tape, insert it into the recorder, record the dictation information, and remove the tape from the recorder when the dictation is complete. The medical professional must then have the tape physically delivered to the transcription location. During this process the tape can be lost, damaged or recorded over prior to transcription resulting in the loss of crucial data. When using a tape recorder, access to prior dictation on the magnetic tape, or access to an earlier portion of the current dictation, is slow and inconvenient because the tape must be physically rewound to the desired location. Upon completion, the transcribed information must be sent back to the medical professional's office. As a result, substantial delay may occur between the time that the audiotape is dictated and the time that the transcribed information is placed in the professional's or patient's records. Moreover, if no hard copy of the information was originally produced, the medical professional may be incapable of adequately reviewing the transcribed information because he or she often has little recollection of its subject matter after the substantial delay.

With respect to telephone dictation, a medical professional accesses and dictates the information to be recorded via a telephone handset and keypad. The information is stored at a remote location on an audiotape. A transcriptionist later transcribes the audiotape. Alternatively, a software program that performs speech recognition may transcribe the information after the medical professional completely dictates it. Typically, an editor or the transcriptionist will review the information for correctness. The resulting information is sent back to the medical professional's office for review at a later time. Thus, a lengthy unavoidable delay between the time that the information is dictated and the time that the medical professional receives the transcribed information may also occur with a telephone dictation system. Moreover, due to the complexity of the language used by medical professionals and the imperfect audio reproduction of the communications systems, errors frequently occur in the transcription output. As a result, the medical professional must review the transcribed information for errors at a time when the information is no longer fresh in his or her mind. Accordingly, the professional may not notice errors in the transcribed information.

Existing methods to remove the delay between dictation and transcription include physically locating a transcriptionist in a medical professional's office and using speech recognition software to transcribe the dictation in real-time. Co-locating the transcriptionist and medical professional is typically impractical because transcriptionists are in short supply and the cost of retaining a dedicated transcriptionist is generally excessive.

With respect to real-time speech recognition, the medical professional dictates information into a PC or workstation that has speech recognition software installed. As the medical professional dictates information, the spoken words are converted to text by the speech recognition software. If an error occurs during dictation the medical professional can either correct the error immediately or return to correct it later. The major drawback to this solution is that the medical professional must correct his/her own transcribed dictation. The dual role of dictator/editor requires the medical professional to take his or her eyes off data (e.g., medical images, lab results, pathology slides and the like) or the patient being referenced during the dictation resulting in slower throughput and potentially more errors as the medical professional switches between reviewing the transcription and reviewing the referenced data. Additionally, self-correction is potentially error prone due to inherent prejudices.

Thus, a need exists for a system and method of providing a transcription system that permits a professional to perform uninterrupted dictation, review the transcribed information, and correct any errors that occur in the transcription in real time.

A further need exists for a system and method of providing a transcription system that permits information to be entered into a professional's or patient's records immediately upon completion of a transcription session.

The disclosed embodiments are directed towards solving one or more of the above-listed problems.

### SUMMARY

Before the present methods and systems are described, it is to be understood that this invention is not limited to the particular methodologies, professions, and systems described, as these may vary. It is also to be understood that the terminology used in the description is for the purpose of describing the particular versions or embodiments only, and is not intended to limit the scope of the present invention which will be limited only by the appended claims.

It must also be noted that as used herein and in the appended claims, the singular forms “a,” “an,” and “the” include plural references unless the context clearly dictates otherwise. Thus, for example, reference to a “network” is a reference to one or more networks and equivalents thereof known to those skilled in the art, and so forth. Unless defined otherwise, all technical and scientific terms used herein have the same meanings as commonly understood by one of ordinary skill in the art. Although any methods, materials, and devices similar or equivalent to those described herein can be used in the practice or testing of embodiments of the present invention, the preferred methods, materials, and devices are now described. All publications mentioned herein are incorporated by reference. Nothing herein is to be construed as an admission that the invention is not entitled to antedate such disclosure by virtue of prior invention.

In an embodiment, a method for performing real-time interactive transcription may include initiating a communication session between a transcriptionist communication device and an author communication device over a communication network, receiving, at the transcriptionist communication device via the communication network, dictation information from the author communication device, transcribing, using the transcriptionist communication device, the dictation information into textual information, and sending the textual information from the transcriptionist communication device to the author communication device over the communication network substantially in real time during the communication session. The method may further include receiving, from the author communication device, real-time edits to the textual information during the communication session. The method may further include editing, using the transcriptionist communication device, the textual information during the communication session. The author communication device and/or the transcriptionist communication device may each include one or more of a personal computer, a workstation, a tablet personal computer, a personal digital assistant, a thin-client application, a plug-in application, and a web site. The dictation information may include audio information and/or video information.

In an embodiment, a method for performing real-time interactive transcription may include receiving a request for a communication session from an author communication device over a communication network, accepting, using a transcriptionist communication device, the request for the communication session by replying to the author communication device over the communication network, receiving, at the transcriptionist communication device via the communication network, dictation information from the author communication device, transcribing, using the transcriptionist communication device, the dictation information into textual information, and sending the textual information from the transcriptionist communication device to the author communication device over the communication network substantially in real time during the communication session.

In an embodiment, a computer system may include a processor, a communication network interface, and a processor-readable storage medium in communication with the processor. The processor-readable storage medium may contain one or more programming instructions for implementing a method for permitting real-time interactive transcription including initiating a communication session between a transcriptionist communication device and an author communication device over a communication network, receiving, at the transcriptionist communication device via the communication network, dictation information from the author communication device, transcribing, using the transcriptionist communication device, the dictation information into textual information, and sending the textual information from the transcriptionist communication device to the author communication device over the communication network substantially in real time during the communication session.

In an embodiment, a system for transcribing information interactively in real time may include a communication network, a first communication device in communication with the communication network providing access to a first software application, a second communication device in communication with the communication network providing access to a second software application, and a server in communication with the communication network. The first software application and the second software application may access a common area of the server to provide a real-time interactive transcription service. The first communication device and/or the second communication device may include a thin-client device. The server may include a third software application for providing text transmission between the first communication device and the second communication device. The first software application and/or the second software application may include a browser-based plug-in for streaming audio information in near real time. The first software application and the second software application may communicate using peer-to-peer technology.

In an embodiment, a computer program in a processor-readable storage medium for use in a real-time interactive transcription system may include first instructions for enabling the initiation of a communication session between a first communication device and a second communication device, second instructions for receiving dictation information from the first communication device and providing the dictation information to the second communication device substantially in real time, third instructions for receiving transcribed information from the second communication device and providing the transcribed information to the first communication device substantially in real time, and fourth instructions for permitting one or more of the first communication device and the second communication device to edit the transcribed information substantially in real time during the communication session.

### BRIEF DESCRIPTION OF THE DRAWINGS

Aspects, features, benefits and advantages of the embodiments of the present invention will be apparent with regard to the following description and the accompanying drawing where:

FIG. 1 depicts an exemplary electronic communication environment and a method for performing transcription according to an embodiment.

FIG. 2 depicts an exemplary process of performing transcription according to an embodiment.

### DETAILED DESCRIPTION

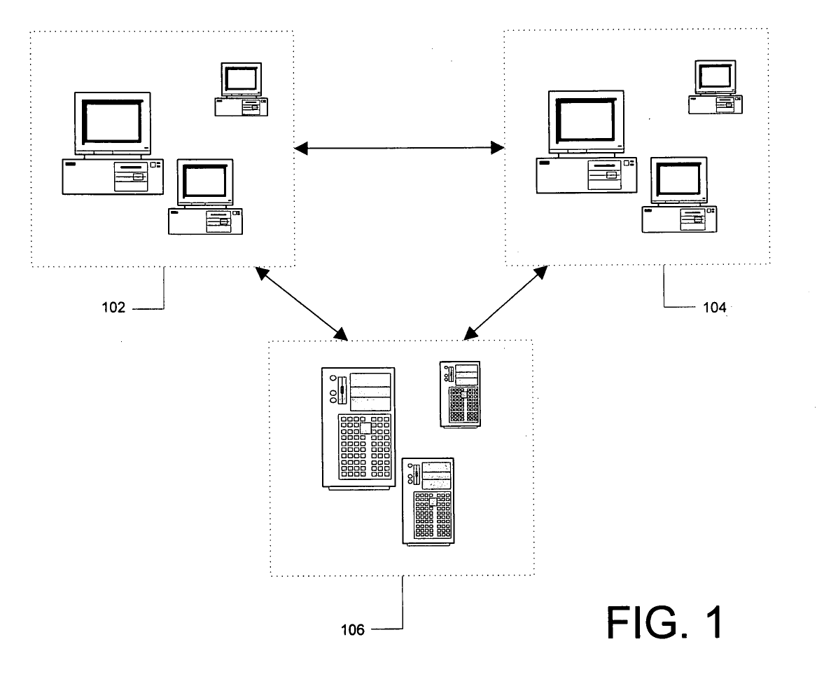

FIG. 1 depicts an exemplary electronic communication environment and a method for performing transcription according to an embodiment. The electronic communications environment may include a first application on an author communication device 102, a second application on a transcriptionist communication device 104 and application web services 106 within a communications network. The author communication device 102 and/or the transcriptionist communication device 104 may include a personal computer, a workstation, a tablet personal computer, a personal digital assistant, a thin-client terminal and/or any other device that may access a communications network. The author communication device 102 and/or the transcriptionist communication device 104 may include software and/or hardware that perform the operations of the first application. The first application may run on the author communication device 102 directly, for example as a thin-client application or plug-in application. Alternatively, the author communication device 102 may access, for example, a web site to run the first application. Similarly, the second application may run on the transcriptionist communication device 104 directly, for example as a thin-client application or plug-in application, or the transcriptionist communication device 104 may access, for example, a web site to run the second application.

In an embodiment, the transcriptionist and the professional may interact using browser-based thin client applications. A web service may provide text transmission from the transcriptionist to the dictator. Audio may be streamed substantially in real time through a browser-based plug-in application using peer-to-peer technology. Client-side scripts may be used to maintain synchronization between the audio control and the client.

The communications network may establish a connection between the first application and the second application using the application web services 106. The connection may be established using the HyperText Transfer Protocol (HTTP), secured HTTP (HTTPS), Transmission Control Protocol/Internet Protocol (TCP/IP), Voice over IP, or any other Internet, telephony or other communication protocols. In an embodiment, communications may be authenticated and secured using an encryption protocol, such as RSA encryption, PGP encryption or triple-DES encryption. A medical professional using the first application and a transcriptionist using the second application may communicate in half-duplex mode or in full-duplex mode. In half-duplex mode, only one party may transmit information at a time. In contrast, full-duplex mode permits each party to transmit information concurrently.

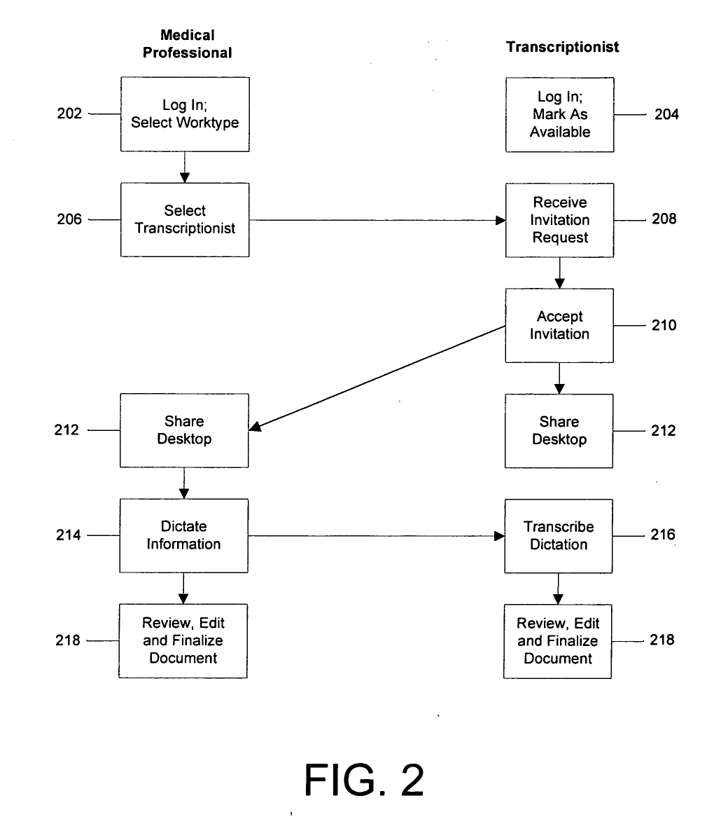

FIG. 2 depicts an exemplary process of performing transcription according to an embodiment. As shown in FIG. 2, a medical professional may log into 202 the first application on the author communication device 102 and select a patient (if applicable) and a work type. The work type may include the type of information that the medical professional wishes to enter. Work types may be based on typical forms that are kept for a professional's records and/or a patient's records. A transcriptionist may log into 204 the second application on the transcriptionist communication device 104 and elect to be able to receive transcription requests. The medical professional may review a list of transcriptionists that are currently available in order to select a preferred transcriptionist 206. In this case, the first application may send a transcription session request 206 to the selected transcriptionist communication device 104. Alternatively, the medical professional may simply elect to communicate with any available transcriptionist 206. In this case, the first application may send a transcription session request 206 to an available transcriptionist communication device 104. Once the transcriptionist communication device 104 receives and displays the request 208, the transcriptionist may elect to accept 210, reject or conditionally accept the request. Acceptance of the request 210 may immediately initiate a new transcription session 212. Rejection of the request may require the medical professional or the system to select a new transcriptionist. A transcriptionist may optionally provide a reason for rejecting the request. Conditional acceptance may require or permit further explanation by the transcriptionist. For example, the transcriptionist may state that he or she will accept the request at a given time in the future, but is incapable of immediately handling the request.

Once a transcription session is initiated, the medical professional and the transcriptionist may share a common “desktop” 212. The desktop 212 may be implemented by a web service that transmits information between the transcriptionist and the professional. The desktop 212 may transmit audio, graphical and/or textual information. In an embodiment, the desktop 212 may further transmit video information if each of the author communication device 102 and the transcriptionist communication device 104 are video-capable and the application web service 106 supports video transfers. As the medical professional dictates information 214, the transcriptionist may receive the information and transcribe it 216. As the information is transcribed, the second application may place the transcribed information on the desktop 212. The first application may then display the information presented on the desktop 212 substantially in real time on the author communication device 102. Preferably, the author communication device 102 may display the transcribed information less than about ten seconds after the information was dictated 214. If the medical professional notices an error in the transcribed information, the professional may edit 218 the transcribed information on the desktop. Alternatively, the medical professional may direct the transcriptionist to edit 218 the transcribed information. If the medical professional edits the transcribed information, the edited text would be transmitted to the desktop 212 via the communication network and displayed on the transcriptionist communication device 104. As a result, the medical professional and/or the transcriptionist may review 218 the transcribed information in real time. When a document has been fully transcribed, the medical professional may approve and close the document 218. The professional may then elect to transcribe further documents or log out of the transcription session.

It is to be understood that the invention is not limited in its application to the details of construction and to the arrangements of the components set forth in this description or illustrated in the drawings. The disclosed method and system are capable of other embodiments and of being practiced and carried out in various ways. Hence, it is to be understood that the phraseology and terminology employed herein are for the purpose of description and should not be regarded as limiting.

As such, those skilled in the art will appreciate that the conception upon which this disclosure is based may readily be utilized as a basis for the designing of other structures, methods and systems for carrying out the several purposes of the present invention. It is important, therefore, that the claims be regarded as including such equivalent constructions insofar as they do not depart from the spirit and scope of the disclosed embodiments.

1. A method for performing real-time interactive transcription, comprising:
initiating a communication session between a transcriptionist communication device and an author communication device over a communication network;
receiving, at the transcriptionist communication device via the communication network, dictation information from the author communication device;
transcribing, using the transcriptionist communication device, the dictation information into textual information; and
sending the textual information from the transcriptionist communication device to the author communication device over the communication network substantially in real time during the communication session.

2. The method of claim 1, further comprising:
receiving, from the author communication device, real-time edits to the textual information during the communication session.

3. The method of claim 1, further comprising:
editing, using the transcriptionist communication device, the textual information during the communication session.

4. The method of claim 1 wherein the author communication device includes one or more of the following:
a personal computer;
a workstation;
a tablet personal computer;
a personal digital assistant;
a thin-client application;
a plug-in application; and
a web site.

5. The method of claim 1 wherein the transcriptionist communication device includes one or more of the following:
a personal computer;
a workstation;
a tablet personal computer;
a personal digital assistant;
a thin-client application;
a plug-in application; and
a web site.

6. The method of claim 1 wherein the dictation information comprises audio information.

7. The method of claim 6 wherein the dictation information further comprises video information.

8. A method for performing real-time interactive transcription, comprising:
receiving a request for a communication session from an author communication device over a communication network;
accepting, using a transcriptionist communication device, the request for the communication session by replying to the author communication device over the communication network;
receiving, at the transcriptionist communication device via the communication network, dictation information from the author communication device;
transcribing, using the transcriptionist communication device, the dictation information into textual information; and
sending the textual information from the transcriptionist communication device to the author communication device over the communication network substantially in real time during the communication session.

9. A computer system, comprising:
a processor;
a communication network interface; and
a processor-readable storage medium in communication with the processor,
wherein the processor-readable storage medium contains one or more programming instructions for implementing a method for permitting real-time interactive transcription, the method comprising:
initiating a communication session between a transcriptionist communication device and an author communication device over a communication network,
receiving, at the transcriptionist communication device via the communication network, dictation information from the author communication device,
transcribing, using the transcriptionist communication device, the dictation information into textual information, and
sending the textual information from the transcriptionist communication device to the author communication device over the communication network substantially in real time during the communication session.

10. A system for transcribing information interactively in real time, comprising:
a communication network;
a first communication device providing access to a first software application, wherein the first communication device is in communication with the communication network;
a second communication device providing access to a second software application, wherein the second communication device is in communication with the communication network; and
a server in communication with the communication network,
wherein the first software application and the second software application access a common area of the server to provide a real-time interactive transcription service.

11. The system of claim 10 wherein the first communication device comprises a thin-client device.

12. The system of claim 10 wherein the second communication device comprises a thin-client device.

13. The system of claim 10 wherein the server includes a third software application for providing text transmission between the first communication device and the second communication device.

14. The system of claim 10 wherein the first software application comprises a browser-based plug-in for streaming audio information in near real time.

15. The system of claim 10 wherein the second software application comprises a browser-based plug-in for streaming audio information in near real time.

16. The system of claim 10 wherein the first software application and the second software application communicate using peer-to-peer technology.

17. A computer program in a processor-readable storage medium for use in a real-time interactive transcription system, the computer program comprising:
first instructions for enabling the initiation of a communication session between a first communication device and a second communication device;
second instructions for receiving dictation information from the first communication device and providing the dictation information to the second communication device substantially in real time;
third instructions for receiving transcribed information from the second communication device and providing the transcribed information to the first communication device substantially in real time; and
fourth instructions for permitting one or more of the first communication device and the second communication device to edit the transcribed information substantially in real time during the communication session.
